(19) United States
(12) Patent Application Publication
(10) Pub. No.: US 2010/0152967 A1
(43) Pub. Date: Jun. 17, 2010

(54) OBJECT DETECTION SYSTEM WITH LEARNED POSITION INFORMATION AND METHOD

(75) Inventors: Morgan D. Murphy, Kokomo, IN (US); Douglas A. Nunan, Kokomo, IN (US)

Correspondence Address: LEON GARFIELD BROWN;DENISE BROWN, 121 CRICKLADE AVENUE, STREATHAM LONDON, EN, SW23HF, GB

(73) Assignee: DELPHI TECHNOLOGIES, INC., Troy, MI (US)

(21) Appl. No.: 12/334,752

(22) Filed: Dec. 15, 2008

(51) Int. Cl. G08G 1/00

(52) U.S. Cl. 701/36; 701/300

(57) ABSTRACT

An object detection system and method of detecting objects and providing an output signal are provided. The system includes a position sensor for sensing position of a host vehicle, and an object detector provided on the host vehicle for detecting presence of an object relative to the host vehicle and for further detecting position of the detected object relative to the host vehicle. The system also includes a controller for processing the sensed position of the host vehicle and determining a current vehicle path as the host vehicle moves. The controller further processes the position of a detected object relative to the host vehicle and determines if the detected object is a stationary object relative to ground. The system further includes memory for storing the position of the detected stationary object and an output for providing an output signal based on the detected stationary object relative to the current vehicle path.

### TECHNICAL FIELD

The present invention generally relates to an object detection system and, more particularly relates to detection of stationary objects in relation to a vehicle.

### BACKGROUND OF THE INVENTION

Wheeled automotive vehicles frequently travel within defined lanes of a roadway, generally based on steering by an operator (driver) of the vehicle. Some vehicles are equipped with object detection systems that are designed to detect one or more objects on or near the roadway. Typical object detection systems may include collision avoidance systems that detect objects and actively steer the vehicle around a potential colliding object. Another object detection system may include an automatic cruise control system that adjusts the vehicle speed based on a detected object. Additionally it should be appreciated that object detection systems may provide a warning alert to the driver of the vehicle, such that the driver is cognizant of the vehicle approaching a detected object.

Conventional object detection systems typically include an object detector for detecting an object relative to a vehicle, generally forward of the vehicle. Some object detectors may include an optical system employing one or more cameras, typically oriented to capture images of the roadway forward of the vehicle. Other object detectors may include one or more radar sensors, infrared sensors, or lasers for detecting objects, such as trees, poles, guardrails, bridges, manhole covers and other objects.

While conventional object detection systems have shown the ability to detect an object relative to the host vehicle, it is desirable to provide for an object detection system that detects stationary objects and makes the detected information available for use on a vehicle.

### SUMMARY OF THE INVENTION

According to one aspect of the present invention, an objection detection system for a vehicle is provided. The system includes a position sensor for sensing position of a host vehicle, and an object detector provided on the host vehicle for detecting the presence of an object relative to the host vehicle and for further detecting position of the detected object relative to the vehicle. The system also includes a controller for processing the sensed position of the host vehicle and determining a current vehicle path as the vehicle moves. The controller further processes the position of a detected object relative to the host vehicle and determines if the detected object is a stationary object relative to ground and stores the location of the stationary object. The system further includes memory for storing position of the detected stationary object, and an output for providing an output signal based on the detected stationary object relative to the current vehicle path.

According to another aspect of the present invention, a method of detecting a stationary object relative to a vehicle is provided. The method includes the steps of sensing position of a host vehicle, detecting the presence of an object relative to the host vehicle and detecting position of the detected object relative to the host vehicle. The method also determines a current vehicle path as the vehicle moves and determines if the detected object is a stationary object relative to ground. The method further includes the steps of storing position of the detected stationary object and providing an output signal based on the detected stationary object relative to the current vehicle path.

These and other features, advantages and objects of the present invention will be further understood and appreciated by those skilled in the art by reference to the following specification, claims and appended drawings.

### BRIEF DESCRIPTION OF THE DRAWINGS

The present invention will now be described, by way of example, with reference to the accompanying drawings, in which:

FIG. 1 is a block diagram of a vehicle employing an object detection system, according to one embodiment;

FIG. 2 is a schematic diagram illustrating one example of sensed vehicle positions on a straight roadway for a learned vehicle path and detected stationary objects;

FIG. 3 is a schematic diagram illustrating another example of sensed vehicle positions on a curved roadway and stationary detected objects;

FIG. 4 is a flow diagram illustrating a routine for learning vehicle paths, according to one embodiment;

FIG. 5 is a flow diagram illustrating a routine for lane marking assist, according to one embodiment; and

FIG. 6 is a flow diagram illustrating an object detection and position learning routine detecting and learning stationary objects relative to a host vehicle, according to one embodiment.

### DESCRIPTION OF THE PREFERRED EMBODIMENTS

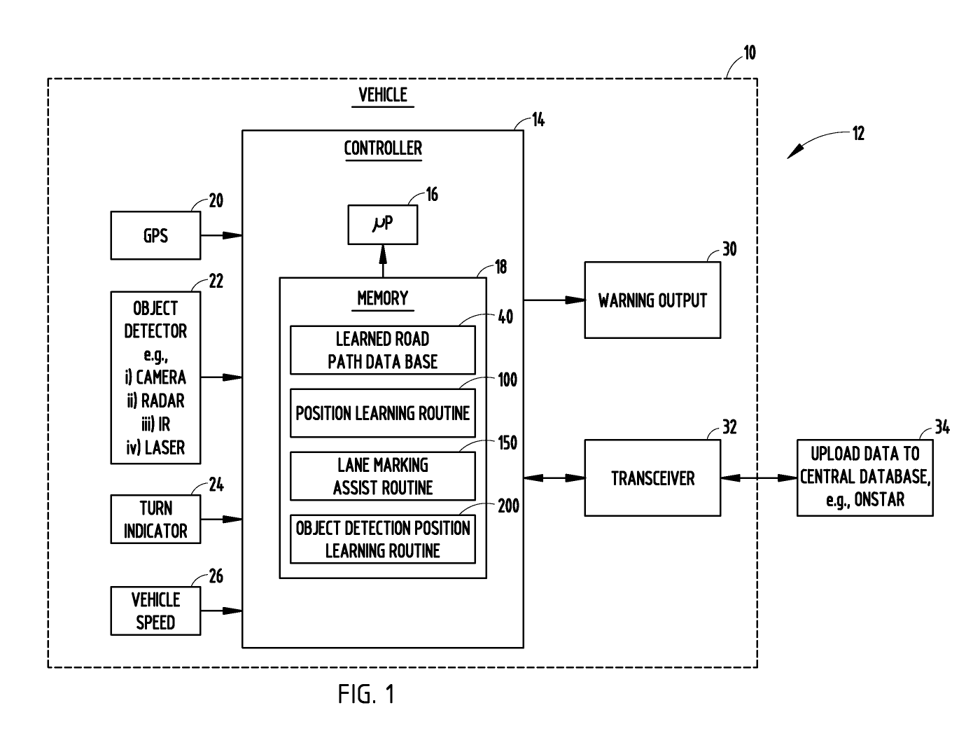

Referring now to FIG. 1, block 10 depicts a vehicle, such as a wheeled automotive vehicle, equipped with an object detection system 12, according to one embodiment. The vehicle 10 may include any of a number of vehicles configured to travel on a path. In the disclosed embodiment, the vehicle 10 is a wheeled vehicle having wheels adapted to engage a roadway, and the vehicle 10 is steerable to maintain the vehicle 10 within a desired path or lane of the roadway. It should be appreciated that the vehicle 10 may be steered by a driver of the vehicle 10 and that the vehicle 10 may be steered on a path, such as within a roadway lane, may depart from the lane so as to move into an adjacent lane, and may approach one or more objects on or near the roadway lane as should be evident to those skilled in the art.

The object detection system 12 is provided on the host vehicle 10 to monitor the position of the vehicle 10, to generate and update learned travel paths or lanes, to detect objects proximate to the vehicle 10 generally in the anticipated path of the vehicle 10, and to provide an output, such as a warning to the operator of the vehicle when an object is detected on or near the roadway. The object detection system 12 may also upload learned travel path and object detection data to a central database, such as OnStar®, to make learned travel path data and detected objects available to other vehicles.

The object detection system 12 includes a controller 14, shown generally having control circuitry in the form of a microprocessor 16 and memory 18. It should be appreciated that the controller 14 may employ other analog and/or digital control circuitry including an application specific integrated circuit (ASIC) or other known circuitry for processing the input data, learning and updating learned travel paths, executing one or more object detection routines, and uploading data to one or more central databases.

Memory 18 may include any known storage medium, such as random access memory (RAM), read-only memory (ROM), electrically erasable programmable read-only memory (EEPROM), flash memory and other memory devices. Stored within memory 18 is a learned road path database 40, a position learning routine 100, a lane marking assist routine 150 and an object detection and position learning routine 200, according to one embodiment. The position learning routine 100 learns new vehicle paths and updates learned vehicle paths. The lane marking assist routine 150 provides for lane departure warning when a lane marking is not sufficiently clear. The learned road path database 40 may contain one or more vehicle paths that have been learned and stored in memory. The learned vehicle paths may include a confidence level indicating the number of times that each vehicle path has been traveled, such that a higher confidence level is indicative of a frequently traveled path and may be considered a lane of the roadway. Also shown stored within memory 18 is the object position learning routine 200 that processes images captured by an object detector, such as a camera, and determines stationary objects and their location relative to the host vehicle 10 such that determined stationary objects and their positions may be employed during future driving events.

It should be appreciated that the position learning routine 100, lane marking assist routine 150 and object detection and position learning routine 200 are each executed by the microprocessor 16. The object detection and position learning routine 200 processes the various inputs to determine whether one or more objects are detected proximate to the vehicle 10 or in the vehicle path, and to provide a warning output when the vehicle is approaching a detected object.

Included in the object detection system 12 is a Global positioning system (GPS) 20 for providing sensed position signals. GPS receiver 20 provides position data input to the controller 14. The position data includes the longitude and latitude position coordinates generated by the GPS receiver 20. It should be appreciated that any of a number of commercially available GPS receivers may be employed to provide the sensed position of the vehicle 10. Current GPS receivers offer a very high accuracy. Some current GPS receivers provide accurate position information to within ±12 meters, while other GPS receivers may provide reliable and better accuracy. With the added assistance of GPS repeaters, the accuracy of the acquired GPS data may be as accurate as +2 cm. While a single GPS receiver 20 is shown, it should be appreciated that a plurality of GPS receivers, such as first and second GPS receivers, may be employed. By employing two GPS receivers on board the vehicle 10 mounted at a known distance apart from each other, enhanced position accuracy may be achieved in addition to determining vehicle yaw. While a GPS receiver 20 is disclosed herein, it should be appreciated that any known position sensing sensor may be employed to sense position of the vehicle 10 for use in the object detection system 12 of the present invention.

The object detection system 12 also includes an object detector 22 providing one or more inputs to the controller 14. The object detector 22 provides a signal with information that indicates the presence of one or more objects detected in the vicinity of the roadway generally in or near the path of the vehicle 10. According to one embodiment, the object detector 22 may include an optical imaging system having one or more cameras for generating images of the roadway in the path of the vehicle 10, generally forward of the vehicle. The camera(s) may capture video images of the roadway which are then processed to detect the presence of an object in the image. The image processing may include know image processing such as pattern recognition to detect each object.

According to another embodiment, the object detector 22 may include one or more radar sensors for sensing objects on the roadway.

According to yet another embodiment, the object detector 22 may include one or more infrared (IR) sensors for sensing objects on the roadway. According to a further embodiment, the object detector 22 may include one or more lasers for detecting objects on or near the roadway. It should be appreciated that the object detector 22 may include any of the above mentioned object in devices individually or in combination to detect the presence of an object on or near the roadway.

The object detector 22 generates a signal indicative of the detection of an object proximate to the host vehicle 10 and indicative of the position of the detected object relative to the vehicle. It should be appreciated that the object detector 22 or the object detection system 12 may process the output signal generated by the object detector 20 and determine the location of a detected object relative to the host vehicle 10 using any of a number of known location detection techniques. For example, the location of a detected object may be determined by obtaining a vector in the direction of the detected object based on triangulation and the distance to the object based on the time required to receive a radar signal.

The object detection system 12 also includes a turn signal indicator 24 indicative of the driver or the host vehicle 10 anticipating a turn by steering the vehicle 10 left or right. Further included as an input to the controller 14 is a vehicle speed signal 26 providing an indication of the speed of the vehicle. Vehicle speed may be sensed by a vehicle speed sensor or may be determined from GPS data. It should further be appreciated that other inputs such as vehicle steering signals may be provided as inputs to the controller 14.

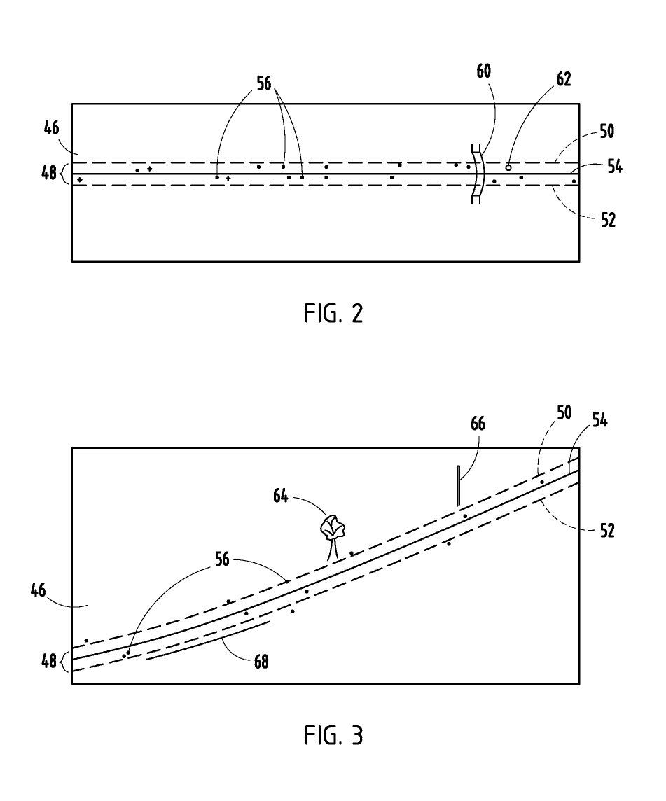

Referring to FIG. 2, an example of sensed GPS data for a vehicle traveling on a straight path or lane 48 on a roadway 46 is illustrated. As the vehicle travels along the roadway 46, the sensed position data 56 is acquired and a spline 54 is acquired which is a line that passes through an average of the sensed position data 56 as shown. The spline 54 is the centerline of the path of travel of the vehicle. Control limits 50 and 52 on either side of the spline 54 are provided to define a width of the learned lane of the roadway. It should be appreciated that if the sensed position data deviates beyond the control limits 50 and 52 to a region outside of the learned lane 48, then a departure of the vehicle from a lane may be detected. The road path is calculated by calculating the spline 54 through recorded position data 56, which may based upon an average of the data points. Updates to the travel path may use ±N data points before and after the sensed location to calculate and update the spline 54. A control limit may be calculated by determining the difference in actual position and projected spline position for the nearest J points (e.g., 20 points). If the control limits are less than a minimum value, then a minimum level may be used.

Also shown present on the roadway 46 are a plurality of objects that may be on or near the lane 48. One object may include a bridge 60 that generally extends from beyond the side boundaries of the lane and extends over the roadway above the lane. Another object that may be on or near the lane 48 is a manhole cover 62 that is provided within the lane 48. These and other objects may be present on the highway and are generally stationary relative to the ground such that the vehicle will likely detect the presence of the same object each time the same vehicle path is traveled. The object detection system 12 of the present invention advantageously detects stationary objects relative to ground such as bridge 60 and manhole cover 62, stores the detected stationary objects and their positions in memory and uses the stored stationary object data for future travel in a vehicle.

Referring to FIG. 3, an example of GPS data sensed for a vehicle traveling on a curved path or lane 48 of a roadway 46 is illustrated. The sensed position data 56 is shown by points 56 in a centerline spline 54 as taken through an average of the sensed position data points. The control limits 50 and 52 are taken on either side of the spline 54. In this situation, the spline 54 is shown as a curved line following a curvature of the roadway 46. If the host vehicle deviates beyond the control limits 54 or 52, then the vehicle may be determined to be departing from the path 48 of the roadway 46. If a given path is known to follow a curve, the vehicle 10 may utilize the learned path information to enhance the operation of the vehicle. For example, vehicle headlights may be directed around corners to provide enhanced visibility based on the learned path curvature, in addition to steering input. Additionally, speed warning can be provided if the operator is traveling too fast based on the learned path.

Additionally, a number of other objects that are stationary relative to the ground are shown and include a tree 64, a telephone pole 66, and a guardrail 68, all located near the lane 48 of the roadway 46. The object detection system 12 of the present invention advantageously detects these and other stationary objects located on or near the lane 48 of the roadway 46, stores each detected stationary object's position in memory and makes the stored stationary object data available for future travel with a vehicle.

The object detection system 10 detects the position and amplitude of detected objects along a path, each time the vehicle travels on the given path. Based on the position and amplitude signal, objects can be categorized into one of a plurality of categorizations. According to one embodiment, detected objects can be categorized as one of known fixed targets and fall-out targets including known fall-out targets and path fall-out targets. Known fixed targets may have a high amplitude and minimal fall off and may include poles (e.g., telephone poles), walls, and trees. For known fixed targets, the object detection system can respond in a unique manner such that the object detection can allow more coasting for target hits, and can operate differently than if a different object, such as a pedestrian, were detected. Known fall-out targets may include manhole covers, bridge overpasses and terrain changes. For known fall-out targets, the object detection system 12 may respond in a less aggressive manner. When stationary targets tend to fall off, the system 12 can track signal amplitude to determine if historical trends and signal readings are followed. For example, a manhole cover may fall-out at fifteen meters from a radar reading, and subsequently operator warnings can be delayed to minimize false warnings. Path fall-out targets may include curves, guardrails, bumps and hills. For path fall-out targets, the system 12 may use past steering input or other inputs to warn of excessive speed.

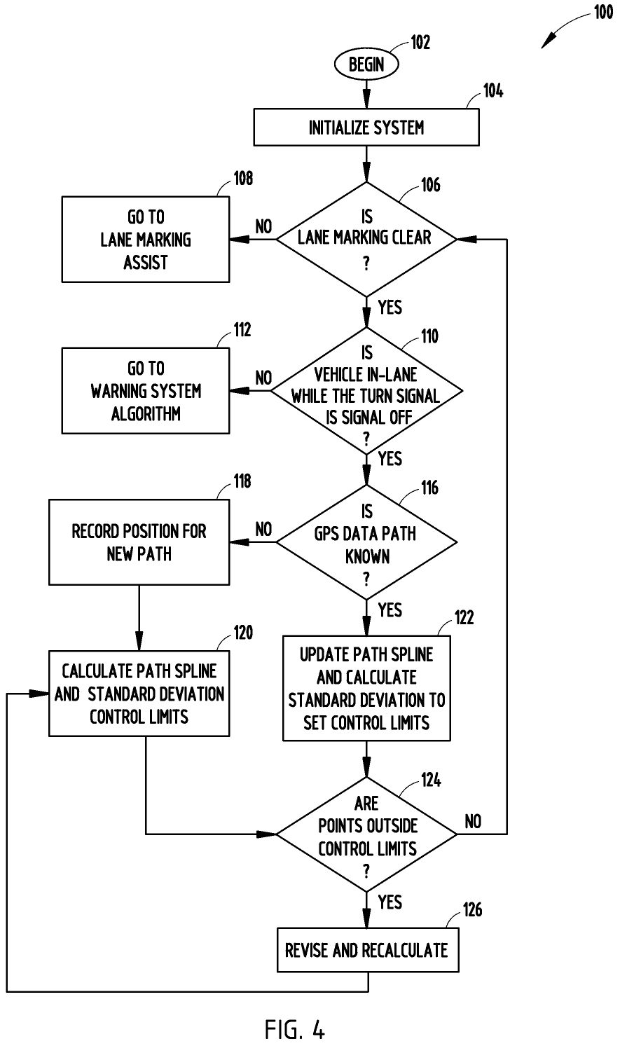

Referring to FIG. 4, the position learning routine 100 is illustrated according to one embodiment. Routine 100 begins at step 102 and proceeds to initialize the system at step 104. Next, routine 100 proceeds to decision step 106 to determine if lane markings are clear such that they are visible and unobstructed. The lane markings may be determined to be clear by processing video images generated by one or more cameras in close proximity to the host vehicle, such as generally in the direction forward of the vehicle. If the lane markings are determined not to be clear, such as when they are covered by snow, leaves, salt, dirt or other matter or are otherwise generally not sufficiently visible, then routine 100 proceeds to step 108 to go to the lane marking assist routine which monitors position of the vehicle within a known path based on sensed position signals and provides a warning when the vehicle departs the path.

If the lane markings are determined to be sufficiently clear, routine 100 proceeds to decision step 110 to determine whether the host vehicle is in a recognized stored lane while the turn signal is off. If the host vehicle is determined not to be in a recognized stored lane of the roadway while the turn signal is off, routine 100 proceeds to step 112 to go to the warning system algorithm to provide a lane departure warning to the vehicle operator. If the vehicle is determined to be within a recognized stored lane while the turn signal is off, routine 100 then proceeds to determine if the path of the host vehicle is a known path in step 116. If the path of the vehicle is not a known path, routine 100 proceeds to step 118 to record the sensed position data for the new vehicle path, and then proceeds to step 120 to calculate a path spline for the new vehicle path and to calculate standard deviation control limits for the new path. The new path data is stored in memory. The standard deviation control limits may be ±5 feet, according to one embodiment, such that the width of a conventional road lane is provided.

If the determined current vehicle path is a known path, as determined by step 116, routine 100 proceeds to step 122 to update the spline path for the known path and to calculate a standard deviation to set control limits for the known path, thereby providing a position update to the known path. The updated spline path and standard deviation data is stored in memory. Following either steps 120 or 122, routine 100 proceeds to step 124 to determine if the current position points are outside of the control limits. If the position points are outside of the control limits, routine 100 proceeds to step 126 to revise and recalculate the path spline and standard deviation control limits. The revised and recalculated path spline and control limits are stored in memory. If the position points are not outside of the control limits, then routine 100 returns to step 106.

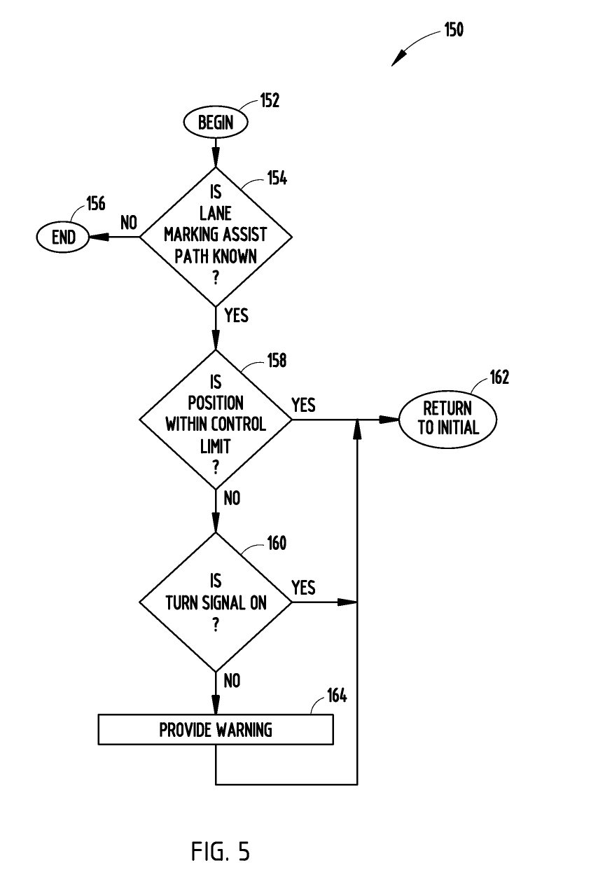

The lane marking assist routine 150 is shown in FIG. 5, according to one embodiment. Routine 150 begins at step 152 and proceeds to decision step 154 to determine if the lane marking is a known path. If the lane marking is not on a known path, routine 150 ends at step 156. If the path is known, routine 50 proceeds to decision step 158 to determine if the current position is within the control limits defining a roadway and, if so, returns to routine 100, particularly the step of initializing the system. If the position is determined not to be within the control limits, then routine 150 determines if the turn signal is on and, if so, returns to routine 100. If the turn signal is not on, routine 150 proceeds to step 164 to provide a lane departure warning output. Accordingly, the lane marking assist routine 150 is used when lane markings are not clear. It should be appreciated that the lane departure warning system 12 may advantageously warn a driver of the host vehicle when the vehicle departs from a lane, beyond the control limits. Further, it should be appreciated that the lane departure warning system 12 may provide a display of the lane and roadway. The display of the lane and roadway may be presented on a head-up display (HUD) projected into the vehicle windshield, generally forward of the vehicle driver, according to one embodiment.

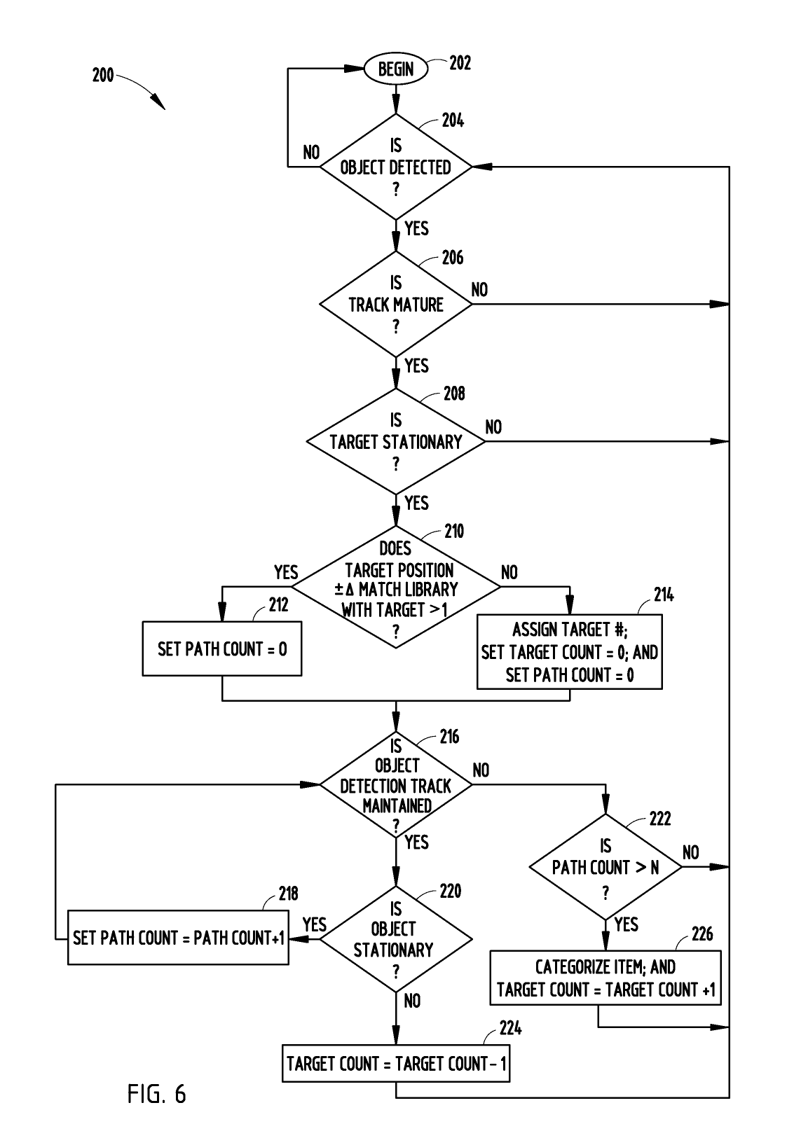

The object detection and position learning routine 200 is illustrated in FIG. 6, according to one embodiment. Routine 200 begins at step 202 and proceeds to decision step 204 to determine if an object is detected and, if not, repeats step 204 until an object is detected. If an object is detected, routine 200 proceeds to decision step 206 to determine if the object detection track is mature and, if not, returns to step 204. The object detection track may be mature based on the number of sequential times that the target has been detected (three times, for example). If the object detection track is determined to be mature, routine 200 proceeds to decision step 208 to determine if the detected target is a stationary object. If the detected target is not a stationary object, then routine 200 returns to step 204. If the detected target is determined to be a stationary object, routine 200 proceeds to decision step 210 to determine whether the target position within limits of ±Δ match a library with target count greater than one and, if so, then the target is associated with the target number and the path count is set equal to zero in step 212. If the target position does not match the library within the limits of ±Δ with the target count greater than one, then routine 200 proceeds to step 214 to assign a target number and sets the target count equal to zero and the path count is set equal to zero. After steps 212 and 214, routine 200 proceeds to decision steps 216 to determine if the object detection track is maintained. If the object track is maintained, routine 200 proceeds to decision step 220 to determine if the object is stationary relative to the roadway ground and, if so, proceeds to step 218 to set the path count equal to the path count plus one, before returning to step 216. The detected object may be categorized as a stationary object in one of a plurality of categorizations including a known fixed target, a known fall-out target, and path fall-out targets, according to one embodiment. If the detected object is not determined to be stationary, then routine 200 proceeds to step 224 to set the target count equal to the target count minus one so as to decrement the target count before returning to step 204. If it is determined at step 216 that the target track is no longer maintained, then routine 200 proceeds to step 222 to determine if the path count is greater than N and, if not, returns to step 204. If the path count is greater than N, routine 200 proceeds to categorize the item as one type of stationary object and to increment the target counter by adding one to the target count at step 226. The detected object may be categorized as a stationary object in one of a plurality of categorizations including a known fixed target, a known fall-out target, and path fall-out targets, according to one embodiment. Next, routine 200 returns to step 204.

By detecting objects and storing the position and amplitude of the detected objects in memory, the object detection system 12 may better inform a driver of the host vehicle 10 as to the condition of the roadway and provide enhanced information made available to vehicle systems. The object detection system 12 can monitor amplitudes for a detected object and if the fall-off matches past driving experiences, a warning might be delayed to the vehicle driver for targets that are known to fall off, such as a manhole cover. If the detected object is a known fixed target, the object detection system 12 may allow more coasting for target hits in the path as it is less likely to be treated as though it is some other object, such as a pedestrian. If the detected object is a fall-out target, such as a guardrail, the object detection system 12 may use past steering input to warn of excessive speed. Thus, the number of false alarms provided to a vehicle operator in an object detection system can be minimized. Additionally, it should be appreciated that routine 200 may be employed for various other systems, such as lane departure warning systems to provide for enhanced system operation.

Accordingly, it should be appreciated that the object detection system 12 and routine 200 advantageously detects stationary objects on or near the roadway of the host vehicle 10, stores the detected stationary object including the position and amplitude in memory, and makes the detected stationary object data available for use in the vehicle. It should further be appreciated that the detected stationary position data may be loaded to a central database, such as OnStar® by way of a transceiver 32. The central database may make the detected and stationary object information available for use on other vehicles.

It will be understood by those who practice the invention and those skilled in the art, that various modifications and improvements may be made to the invention without departing from the spirit of the disclosed concept. The scope of protection afforded is to be determined by the claims and by the breadth of interpretation allowed by law.

1. An objection detection system for a vehicle comprising:
a position sensor for sensing position of a host vehicle;
an object detector provided on the host vehicle for detecting the presence of an object relative to the host vehicle and for further detecting position of the detected object relative to the host vehicle;
a controller for processing the sensed position of the host vehicle and determining a current vehicle path as the host vehicle moves, said controller further processing the position of a detected object relative to the host vehicle and determining if the detected object is a stationary object relative to ground;
memory for storing position of the detected stationary object; and
an output for providing an output signal based on the detected stationary object relative to the current vehicle path.

2. The object detection system as defined in claim 1, wherein the controller determines the current vehicle path based on a learned vehicle path.

3. The system as defined in claim 1, wherein the controller learns the current vehicle path based on sensed position of the host vehicle.

4. The system as defined in claim 3, wherein the controller generates a spline path generally centered about the sensed position data of the host vehicle and compares the path data to control limits relative to the spline path to define a road lane.

5. The system as defined in claim 1, wherein the controller further determines if the detected object has been detected as a stationary object multiple times.

6. The system as defined in claim 5, wherein the controller determines if the detected object has been detected at least three different times at the same location.

7. The system as defined in claim 1, wherein the controller further assigns a confidence level to the detected stationary object, wherein the controller determines that an object is stationary when the confidence level exceeds a threshold level.

8. The system as defined in claim 1, wherein the position sensor comprises a global positioning system (GPS) receiver.

9. The system as defined in claim 1, wherein the vehicle is a wheeled vehicle traveling on a roadway.

10. The system as defined in claim 1, wherein the controller categorizes a detected object as one of a known fixed target and a fall-out target.

11. A method of detecting a stationary object relative to a vehicle, said method comprising the steps of:
sensing position of a host vehicle;
detecting the presence of an object relative to the host vehicle;
detecting position of the detected object relative to the host vehicle;
determining a current vehicle path as the host vehicle moves;
determining if the detected object is a stationary object relative to ground;
storing position of the detected stationary object in memory; and
providing an output signal based on the detected stationary object relative to the current vehicle path.

12. The method as defined in claim 11 further comprising the step of learning a vehicle path, wherein the current vehicle path is a learned vehicle path.

13. The method as defined in claim 12, wherein the current vehicle path is learned based on sensed position of the host vehicle.

14. The method as defined in claim 13, wherein the current vehicle path is learned by generating a spline path generally centered about sensed position data of the host vehicle and the path data is compared to control limits relative to the spline path to define a road lane.

15. The method as defined in claim 11 further comprising the step of determining if the detected object has been detected as a stationary object multiple times.

16. The method as defined in claim 15, wherein the step of determining if the detected object has been detected as a stationary object multiple times comprises detecting at least three different times at the same location.

17. The method as defined in claim 11 further comprising the step of assigning a confidence level to detected stationary object, wherein the object is determined to be stationary when the confidence level exceeds a threshold level.

18. The method as defined in claim 11 further comprising the step of categorizing the detected object as one of a known fixed target and a fall-out target.

19. The method as defined in claim 11 further comprising the step of controlling an object detection system based on the output signal.

20. The method as defined in claim 19, wherein the step of controlling the object detection system comprises controlling a warning output as a function of the output signal.
